(19) United States
(12) Patent Application Publication
(10) Pub. No.: US 2025/0312239 A1
(43) Pub. Date: Oct. 9, 2025

(54) EXTRACTORS AND METHODS OF USING

(71) Applicant: Antione Pierson, Gary, IN (US)

(72) Inventor: Antione Pierson, Gary, IN (US)

(21) Appl. No.: 19/170,562

(22) Filed: Apr. 4, 2025

Related U.S. Application Data
(60) Provisional application No. 63/574,377, filed on Apr. 4, 2024.

(51) Int. Cl. A61J 1/20

(52) U.S. Cl. CPC A61J 1/201; A61J 1/2096

(57) ABSTRACT

Extractors and methods of extracting a medication from another medical device, such as an insulin pen. The extractor includes a syringe, a first cap having an open end adapted to be coupled to the syringe, a hypodermic needle protruding from a closed end of the first cap, and a second cap coupled at a closed end thereof to the first cap by the hypodermic needle, which extends through the closed end of the second cap and protrudes into an internal cavity of the second cap such that an internal cavity of the first cap fluidically communicates with the internal cavity of the second cap through the hypodermic needle. An open end of the second cap can be coupled to the medical device so that the internal cavity of the second cap fluidically communicates with the medical device through the hypodermic needle.

### CROSS-REFERENCE TO RELATED APPLICATIONS

This application claims the benefit of provisional U.S. Patent Application No. 63/574,377 filed Apr. 4, 2024, the contents of which are incorporated herein by reference.

### BACKGROUND OF THE INVENTION

The present invention generally relates to medical devices, and more particularly relates to an extractor for extracting a medication from other medical devices, such as insulin pens, a cap assembly for the extractor, and related methods of using the same.

Individuals with Type 2 diabetes are required to take insulin shots, for example, using a medical device that is commonly referred to as an insulin pen. There is a risk that an individual may run out of insulin before their next doctor appointment. Such a risk is exacerbated by the fact that the individual may not be able to access a residual portion of the insulin (e.g., about 20 cc) within the insulin pen, resulting not only in wasted insulin but added cost to the individual and/or their insurance provider. Because insulin is commonly sold by boxes of insulin pens and not as individual pens, if an individual falls short of insulin they must buy an entire box of insulin pens.

In view of the above, it would be desirable if devices and methods were available that were capable of accessing residual portions of insulin in used insulin pens that would otherwise go to waste.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, extractors for extracting medication from medical devices, cap assemblies for extractors, and methods of using the extractors and cap assemblies, for example, for extracting a medication from another medical device, such as an insulin pen.

According to a nonlimiting aspect of the invention, an extractor includes a syringe, a first cap having an open end adapted to be coupled to the syringe, a hypodermic needle protruding from a closed end of the first cap, and a second cap releasably coupled at a closed end thereof to the first cap. The hypodermic needle extends through the closed end of the second cap and protrudes into an internal cavity of the second cap such that an internal cavity of the first cap fluidically communicates with the internal cavity of the second cap through an internal lumen of the hypodermic needle. An open end of the second cap is adapted to be coupled to the medical device so that the internal cavity of the second cap fluidically communicates with the medical device through the internal lumen of the hypodermic needle.

According to another nonlimiting aspect of the invention, a method is provided for using the extractor described above to extract a medication from another medical device, including but not limited to insulin from an insulin pen.

According to a further aspect of the invention, a cap assembly is provided for coupling a syringe to a medical device for extracting residual medication from the medical device into the syringe. The cap assembly includes a first cap having an open end and a closed end, the open end being adapted to be coupled to a closure of the syringe, and the first cap having an internal cavity and a hypodermic needle protruding from the closed end of the first cap, the hypodermic needle having an internal lumen. The cap assembly also includes a second cap having an open end and a closed end, the closed end of the second cap being releasably mountable to the first cap. The hypodermic needle extends through the closed end of the second cap and protrudes into an internal cavity of the second cap such that the internal cavity of the first cap fluidically communicates with the internal cavity of the second cap through the internal lumen of the hypodermic needle. The open end of the second cap is adapted to be coupled to the medical device so that the internal cavity of the second cap can fluidically communicate with the medical device through the internal lumen of the hypodermic needle.

In yet another aspect of the invention, a method of using the cap assembly includes mounting the open end of the first cap to a syringe, mounting the open end of the second cap to the medical device, extracting residual medication from the medical device into the syringe through the cap assembly using a plunger of the syringe, and decoupling the second cap from the first cap to expose a distal end of the hypodermic needle with the first cap mounted to the syringe.

Technical effects of extractors and methods as described above preferably include the ability to extract small residual portions of a medication from a medical device to reduce waste and costs associated with using the medication.

Other aspects and advantages will be appreciated from the following detailed description as well as any drawings.

### BRIEF DESCRIPTION OF THE DRAWINGS

FIG. 1 is an axial cross-sectional view of an extractor arranged for extracting residual medication (such as insulin) from a medical device (such as an insulin pen) in accordance with a nonlimiting embodiment of this invention.

FIG. 2 is a side view of a syringe of the extractor of FIG. 1.

FIGS. 3 and 4 are perspective views of caps of the extractor of FIG. 1 in accordance with nonlimiting embodiments of this invention.

FIG. 5 is a perspective view showing the assembly of the caps of FIGS. 3 and 4 in accordance with a nonlimiting embodiment of this invention.

FIG. 6 is a perspective view of the extractor for extracting residual medication in an assembled configuration.

FIG. 7 is an enlarged partial axial cross-sectional view of the syringe and the caps in the assembled configuration.

FIG. 8 is an exploded view of the extractor and medical device.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including embodiment(s) depicted in the drawings. The following detailed description also identifies certain, but not all alternatives of the embodiment(s) depicted in the drawings. As nonlimiting examples, the invention encompasses additional or alternative embodiments in which one or more features or aspects shown and/or described as part of a particular embodiment could be eliminated and also encompasses additional or alternative embodiments that combine two or more features or aspects shown and/or described as part of different embodiments. Therefore, the appended claims, and not the detailed description, are intended to particularly point out subject matter regarded as aspects of the invention, including certain but not necessarily all of the aspects and alternatives described in the detailed description.

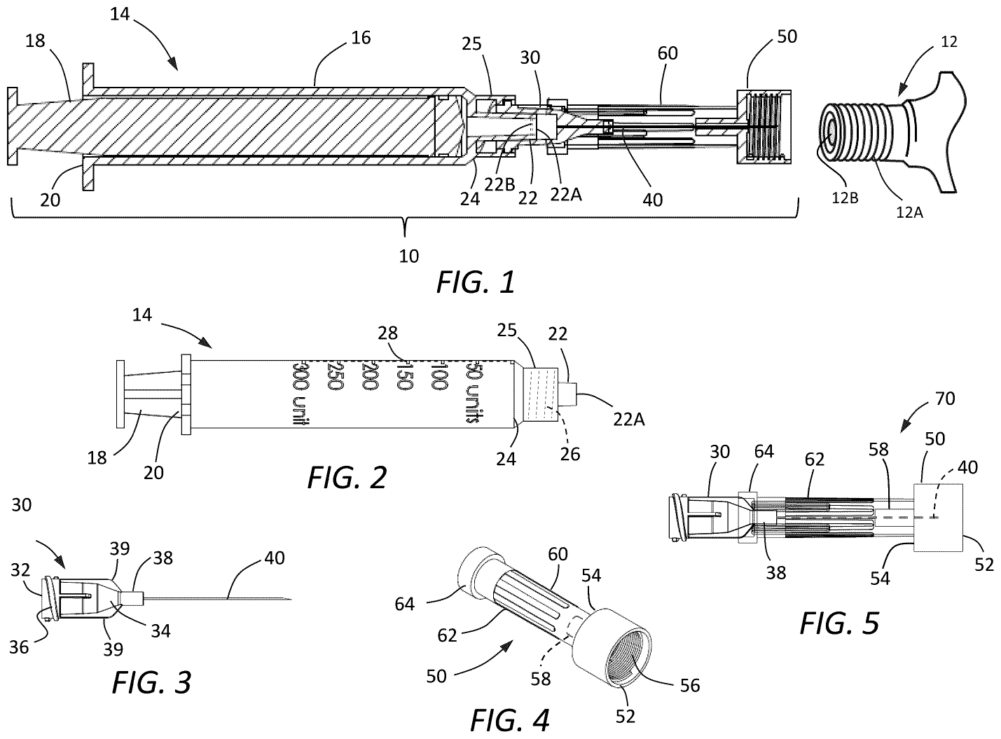

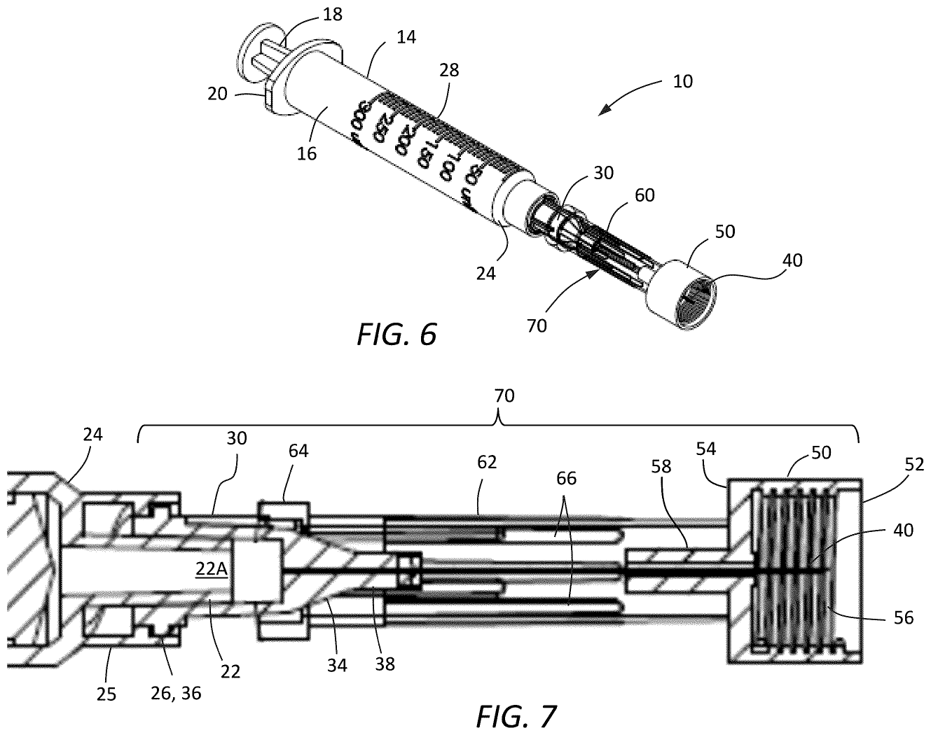

The following disclosure describes various aspects of extractors 10 and components thereof schematically represented in FIGS. 1 through 8 and methods for using such extractors 10. To facilitate the description provided below of the extractors 10 represented in the drawings, relative terms may be used in reference to the orientation of the extractors 10 as represented in the drawings. All such relative terms are intended to indicate the construction and relative orientations of components and features of the extractors 10, and therefore are relative terms that are useful to describe the illustrated embodiments but should not be otherwise interpreted as limiting the scope of the invention.

FIG. 1 schematically represents an extractor 10 arranged for extracting a medication from a medical device 12, as a nonlimiting example, an insulin pen. The extractor 10 includes a syringe 14 (depicted in isolation in FIG. 2) having a barrel 16, a plunger 18 reciprocably received in a bore of the barrel 16 and protruding from a first end 20 of the barrel 16, and a closure 22 disposed at a second end 24 of the barrel 16. In this example, a generally cylindrical collar 25 extends axially from the second end 24. The collar 25 surrounds and is spaced apart from the outer surface of the closure 22, thereby forming an annular gap therebetween. A set of interior threads 26 are disposed on the radially inner wall of the cylindrical collar. In other embodiments, the closure 22 may include optional male threads on its radially outer surface in addition to or alternatively to the interior threads 26. The barrel 16 is represented as having graduated markings 28 by which the volume of a medication within the syringe 14 can be measured. The closure 22 defines an opening 22A that may be closed by a seal 22B, such as a self-sealing diaphragm, or may be left open.

The extractor 10 further includes a first cap 30 (depicted in isolation in FIG. 3) having an open end 32 and a closed end 34. The open end 32 is adapted to be coupled to the closure 22 of the syringe 14. In this nonlimiting example, the open end 32 screws into the annular gap between the cylindrical collar 25 and the closure 22 with the internal and/or external threads 36 adapted to threadably couple with the complementary optional threads 26 at the closure 22 of the syringe 14. The first cap 30 has an internal cavity, and a hypodermic needle 40 protrudes axially from a hub 38 disposed at the closed end 34. In some configurations, the needle 40 may protrude into the internal cavity of the first cap 30 so that when the cap 30 is assembled with the syringe 14, the needle 40 pierces the seal 22B of the syringe 14. In other configurations, the needle 40 may not extend into the internal cavity of the first cap 30, for example, if no seal 22B covers the opening 22A or fluid can pass through the seal under pressurization from extracting and/or advancing the plunger 18. The needle 40 may, as a nonlimiting example, have a length of about 4 mm and a diameter of about 0.23 mm, and conventionally has an internal lumen (not shown) through which a medication can flow from and into the bore of the syringe 14.

The extractor 10 also includes a second cap 50 (depicted in isolation in FIG. 4) having an open end 52 and a closed end 54. The second cap 50 is coupled at its closed end 54 to the first cap 30 by a combination of the hypodermic needle 40 and a coupler 60. The hypodermic needle 40 extends through the closed end 54 of the second cap 50 and protrudes into an internal cavity of the second cap 50 such that the internal cavity of the first cap 30 fluidically communicates with the internal cavity of the second cap 50 through the internal lumen of the hypodermic needle 40, as evident in FIG. 1. The hypodermic needle 40 is shown in FIG. 5 as being received through a hub 58 disposed at the closed end 54 of the second cap 50.

The coupler 60 extends axially from the closed end 54 of the second cap and releasably couples to the closed end of the first cap 30 to provide a firm coupling between that two caps 30 and 50 and minimize or eliminate undesired flexural strains on the hypodermic needle 40. In this example, the coupler 60 includes an axially elongate cage 62 that extends axially from the closed end 54 of the second cap and a coupling collar 64 disposed at the distal end of the cage to releasably mount onto the first cap 30. The cage 62 surrounds and is spaced apart radially from the needle 40 to protect the needle 40. The cage 62 may also surround and be radially spaced apart from the hub 58 so that flexural strains experienced by the coupler 60 are not transmitted to the needle 40 or the hub 58. In this example, the cage 62 is formed by a clear tube (e.g., clear plastic) that protects the needle 40 and user while allowing the user to see the needle as it is being inserted into the insulin pen. The cage 62 optionally includes one or more axial reinforcing ribs 66 that extend part way from the collar 64 toward the second cap 50 to provide added flexural strength. In some embodiments, the cage 62 may be formed with openings therethrough, such as by being formed by elongate ribs or a mesh structure that does not completely enclose the interior surrounding the hypodermic needle 40, or various combinations of a solid tube, ribs, and/or mesh structure suitable for protecting the hypodermic needle from flexural strain. The coupling collar 64 is configured to slide onto and form a snug friction-fit mating coupling with an exterior surface of the distal end of the first cap 30. In this example, a set of radial ribs 39 protrude radially outwardly from the distal end 34 of the first cap 30 to form engagement surfaces that engage the inner surface of the coupling collar 64; however, other configurations for the mating coupling may be implemented, such as by omitting the radial ribs 39. This coupling arrangement allows the first and second caps 30 and 50 to be releasably mounted together during storage and/or use while extracting serum from the medical device 12. When it is desired to then inject any extracted serum from the syringe 14, the user can easily remove the second cap 50 from the first cap 30 and the hypodermic needle 40 to expose the distal end of hypodermic needle 40 for subsequent injection.

The open end 52 of the second cap 50 is adapted to be coupled to the medical device 12 so that the internal cavity of the second cap 50 fluidically communicates with an internal volume of the medical device 12 through the internal lumen of the hypodermic needle 40. In the case where the medical device 12 is an insulin pen, the second cap 50 may have internal threads 56 adapted to threadably couple with complementary external threads 12A of the device 12 so as to result in the hypodermic needle 40 piercing a self-sealing diaphragm or other type of seal 12B of the device 12.

FIGS. 5 to 7 illustrate the first and second caps 30 and 50 provided as a pre-assembled cap assembly 70 for the extractor 10 with the first and second caps 30 and 50 pre-assembled as a unitary, separable component that can be subsequently mounted to the syringe 14. This cap assembly configuration may be useful for providing the first and second caps 30 and 50 in this pre-assembled configuration that a user may then subsequently mount to a separate syringe 14. For example, the user may purchase the pre-assembled caps 30 and 50 as a kit and then mount the first cap 30 portion of the pre-assembled caps to a re-usable syringe. In some embodiments, such a kit may provide the first and second caps 30 and 50 in an unassembled condition so that the user can assembly the caps together before mounting the cap assembly 70 to the syringe 16.

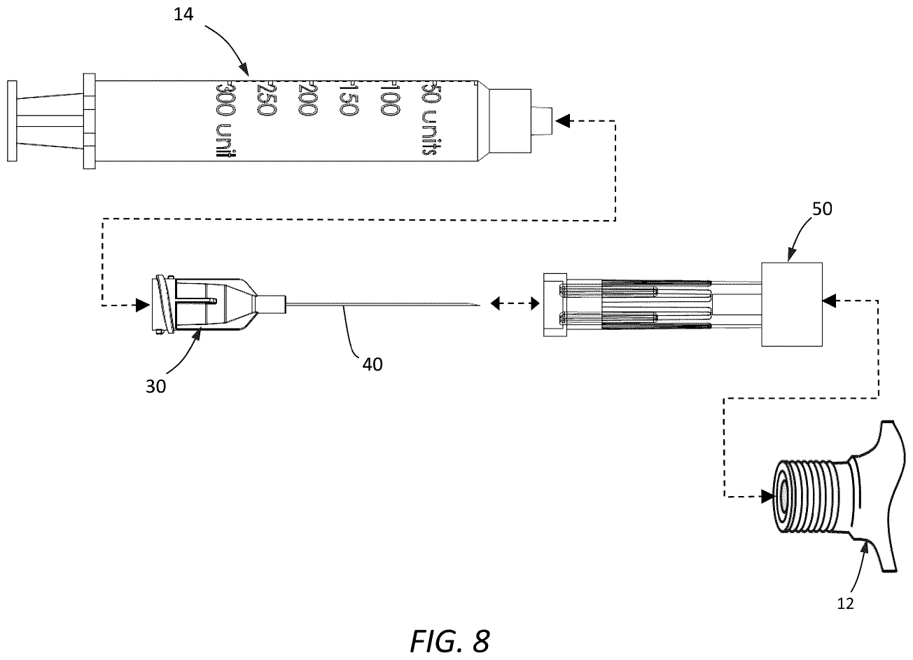

Turning to FIG. 8, in use, the extractor 10 is able to extract residual medication from the medical device 12 by coupling the open end 52 of the second cap 50 to the medical device 12 such that the hypodermic needle 40 pierces the self-sealing diaphragm 12B of the medical device 12, and then extracting the residual medication from the medical device 12 by operating the plunger 18 of the syringe 14 so that the residual medication within the medical device 12 is transferred to the bore of the syringe 14 through the hypodermic needle 40. Thereafter, the user may remove the second cap 50 from the first cap 30 and the hypodermic needle 40 while the first cap is still mounted to the syringe 14 to expose the distal end of the needle for injecting extracted serum by simply sliding the coupling collar 64 off of the radial ribs 39.

As previously noted above, though the foregoing detailed description describes certain aspects of one or more particular embodiments of the invention, alternatives could be adopted by one skilled in the art. For example, the extractors 10 and their components could differ in appearance and construction from the embodiments described herein and shown in the drawings, functions of certain components of the extractors 10 could be performed by components of different construction but capable of a similar (though not necessarily equivalent) function, and various materials, such as metals, polymers, and/or glass, could be used in the fabrication of the extractors 10 and/or their components. In addition, it is foreseeable that the extractors 10 could become battery-powered, electrically-powered or the like. As such, and again as was previously noted, it should be understood that the invention is not necessarily limited to any particular embodiment described herein or illustrated in the drawings.

1. An extractor for extracting a medication from a medical device, the extractor comprising:
a syringe comprising a barrel, a plunger reciprocably received in a bore of the barrel at a first end of the barrel, and a closure disposed at a second end of the barrel;
a first cap having an open end and a closed end, the open end being adapted to be coupled to the closure of the syringe, the first cap having an internal cavity and a hypodermic needle protruding from the closed end of the first cap, the hypodermic needle having an internal lumen; and
a second cap having an open end and a closed end, the second cap being releasably coupled at the closed end thereof to the first cap, wherein the hypodermic needle extends through the closed end of the second cap and protrudes into an internal cavity of the second cap such that the internal cavity of the first cap fluidically communicates with the internal cavity of the second cap through the internal lumen of the hypodermic needle, the open end of the second cap being adapted to be coupled to the medical device so that the internal cavity of the second cap fluidically communicates with the medical device through the internal lumen of the hypodermic needle.

2. The extractor of claim 1, wherein the second cap is coupled to the first cap at least in part by the hypodermic needle.

3. The extractor of claim 1, wherein the second cap further comprises:
a coupler that extends from the closed end of the second cap and releasably couples to the first cap, thereby releasably coupling the first cap to the second cap.

4. The extractor of claim 3, wherein the coupler comprises:
a cage extending axially from the closed end of the second cap, wherein the cage at least partly surrounds; and
a coupling collar disposed at a distal end of the cage, wherein the coupling collar releasably mounts to the first cap.

5. The extractor of claim 4, wherein the cage is radially spaced from the hypodermic needle.

6. The extractor of claim 4, wherein the cage is made at least partly of a transparent material that allows a user to see the needle therein.

7. The extractor of claim 1, wherein the hypodermic needle extends protrudes into the internal cavity of the first cap and configured to puncture a cover over an opening through the closure into the barrel of the syringe.

8. The extractor of claim 1, wherein the medical device is an insulin pen.

9. The extractor of claim 1, further comprising threads disposed at the closure of the syringe and threads disposed at the open end of the first cap for threadably coupling the first cap to the threads at the closure of the syringe.

10. The extractor of claim 1, wherein the first and second caps are integrated as a unitary component that can be assembled to the syringe.

11. A method of using the extractor of claim 1 to extract a residual medication from the medical device, the method comprising:
coupling the open end of the second cap to the medical device such that the hypodermic needle pierces a seal of the medical device; and
extracting the residual medication from the medical device by operating the plunger of the syringe so that the residual medication within the medical device is transferred to the bore of the syringe through the hypodermic needle.

12. A cap assembly for coupling a syringe to a medical device for extracting residual medication from the medical device into the syringe, the cap assembly comprising:
a first cap having an open end and a closed end, the open end being adapted to be coupled to a closure of the syringe, the first cap having an internal cavity and a hypodermic needle protruding from the closed end of the first cap, the hypodermic needle having an internal lumen; and
a second cap having an open end and a closed end, the closed end of the second cap being releasably mountable to the first cap, wherein the hypodermic needle extends through the closed end of the second cap and protrudes into an internal cavity of the second cap such that the internal cavity of the first cap fluidically communicates with the internal cavity of the second cap through the internal lumen of the hypodermic needle, and wherein the open end of the second cap is adapted to be coupled to the medical device so that the internal cavity of the second cap can fluidically communicates with the medical device through the internal lumen of the hypodermic needle.

13. The cap assembly of claim 12, wherein the second cap is coupled to the first cap at least in part by the hypodermic needle.

14. The cap assembly of claim 12, wherein the second cap further comprises:
a coupler that extends from the closed end of the second cap and releasably couples to the first cap, thereby releasably coupling the first cap to the second cap.

15. The cap assembly of claim 14, wherein the coupler comprises:
a cage extending axially from the closed end of the second cap, wherein the cage at least partly surrounds; and
a coupling collar disposed at a distal end of the cage, wherein the coupling collar releasably mounts to the first cap.

16. The cap assembly of claim 15, wherein the cage is radially spaced apart from the hypodermic needle.

17. The cap assembly of claim 15, wherein the first cap comprises a plurality of radial ribs at the closed end of the first cap, and wherein the coupling collar forms a friction fit mating coupling around the radial ribs.

18. The cap assembly of claim 15, wherein the second cap comprises a hub disposed at the closed end of the second cap, and wherein the hypodermic needle is received through the hub.

19. The cap assembly of claim 18, wherein the cage at least partly surrounds and is radially spaced apart from the hub.

20. A method of using the cap assembly of claim 12 to extract residual medication from a medical device, the method comprising:
mounting the open end of the first cap to a syringe;
mounting the open end of the second cap to the medical device;
extracting residual medication from the medical device into the syringe through the cap assembly using a plunger of the syringe; and
decoupling the second cap from the first cap to expose a distal end of the hypodermic needle with the first cap mounted to the syringe.
